(19) United States
(12) Patent Application Publication
(10) Pub. No.: US 2025/0206576 A1
(43) Pub. Date: Jun. 26, 2025

(54) CRANE

(71) Applicant: SUMITOMO HEAVY INDUSTRIES, LTD., Tokyo (JP)

(72) Inventors: Yasuhiro YAMAMOTO, Yokosuka-shi (JP); Chunnan WU, Yokosuka-shi (JP); Fuminori MAKINO, Yokosuka-shi (JP); Hisashi OSUMI, Tokyo (JP)

(21) Appl. No.: 18/983,354

(22) Filed: Dec. 17, 2024

(30) Foreign Application Priority Data
Dec. 22, 2023 (JP) 2023-216773

(51) Int. Cl. B66C 13/06; B66C 23/36

(52) U.S. Cl. CPC B66C 13/063; B66C 23/36

(57) ABSTRACT

A crane includes a rotating platform, and a boom capable of being derricked with respect to the rotating platform, in which the crane automatically increases and decreases a derricking angle of the boom to suppress a swing of a suspended load when the rotating platform turns to move the suspended load.

### CROSS-REFERENCE TO RELATED APPLICATIONS

This application claims priority to Japanese Patent Application No. 2023-216773, filed on Dec. 22, 2023, which is incorporated by reference herein in its entirety.

### BACKGROUND

### Technical Field

A certain embodiment of the present invention relates to a crane.

### Description of Related Art

The related art discloses swing suppression control of stopping a swing (pendulum motion) of a suspended load caused when a crane turns. In the swing suppression control, a boom suspending point radius is reduced when a boom turns, and, at the same time, a wire rope that suspends the suspended load is unwound to stop the swing of the suspended load.

### SUMMARY

According to an embodiment of the present invention, there is provided a crane including: a rotating platform; and a boom capable of being derricked with respect to the rotating platform, in which the crane automatically increases and decreases a derricking angle of the boom to suppress a swing of a suspended load when the rotating platform turns to move the suspended load.

### BRIEF DESCRIPTION OF THE DRAWINGS

FIG. 1 is a block diagram showing a crane according to the present embodiment.

FIG. 2 is a flowchart showing mode switching processing executed by a mode switching control unit.

FIG. 3 is a flowchart showing manual operation processing executed by a manual operation control unit.

FIG. 4 is a flowchart showing automatic operation processing executed by an automatic operation control unit.

FIG. 5 is a flowchart showing swing suppression operation processing executed by a swing suppression mode operation control unit.

FIG. 6 is a time chart showing an automatic operation example 1 of the embodiment.

FIGS. 7A to 7D are phase plane trajectory diagrams showing a first stage to a fourth stage for describing a principle of swing suppression in a turning direction, respectively.

FIGS. 8A to 8D are phase plane trajectory diagrams showing a first stage to a fourth stage for describing a principle of swing suppression in an orthogonal direction, respectively.

FIGS. 9A and 9B are a phase plane trajectory diagram in the turning direction and a phase plane trajectory diagram in the orthogonal direction, respectively, the phase plane trajectory diagrams showing a simulation result of the automatic operation example 1.

FIGS. 10A and 10B are a phase plane trajectory diagram in the turning direction and a phase plane trajectory diagram in the orthogonal direction, respectively, in a case where the swing suppression is not performed.

FIG. 11 is a time chart showing an automatic operation example 2 of the embodiment.

FIG. 12 is a time chart showing an automatic operation example 3 of the embodiment.

FIG. 13 is a time chart showing an operation example of a swing suppression mode.

FIGS. 14A to 14C are a phase plane trajectory diagram in a turning direction q, a phase plane trajectory diagram in an orthogonal direction r, and a trajectory diagram of a suspended load, respectively, the phase plane trajectory diagrams showing a simulation result in the swing suppression mode.

### DETAILED DESCRIPTION

However, when the swing suppression is performed only by unwinding the wire rope as in the swing suppression control in the related art, an unwinding speed of the wire rope is slow, and thus there is a problem in that a speed necessary to stop the swing cannot be guaranteed.

It is desirable to provide a crane that can efficiently suppress a swing of a suspended load caused by a turning.

Hereinafter, each embodiment of the present invention will be described in detail with reference to the drawings.

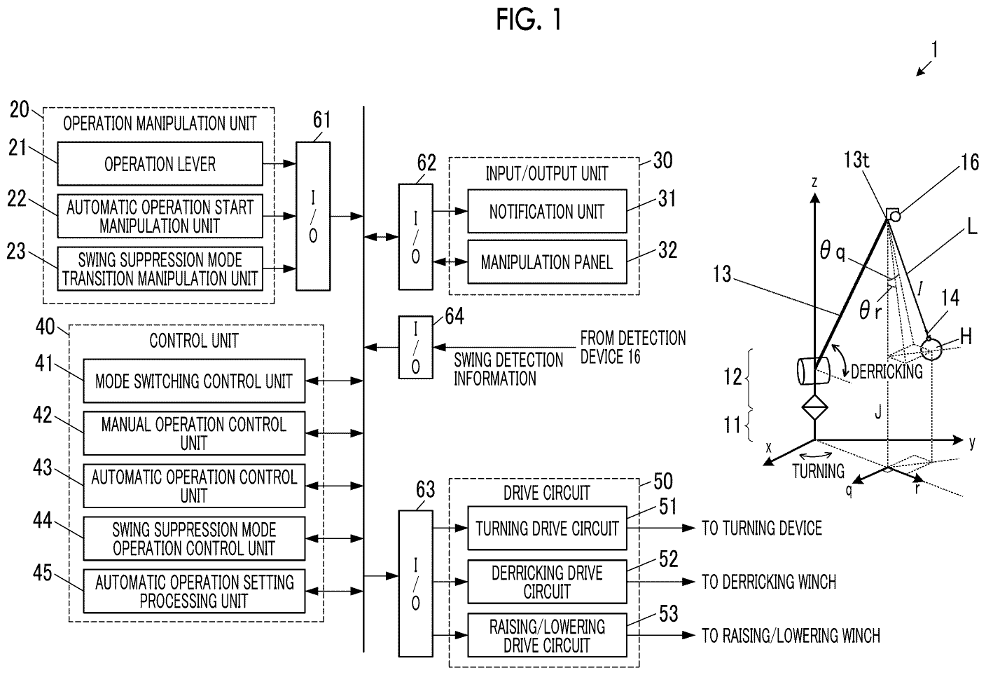

FIG. 1 is a block diagram showing a crane according to the present embodiment. A crane 1 according to the present embodiment includes a lower structure 11, a rotating platform 12 that is driven to turn with respect to the lower structure 11, a boom (derricking member) 13 that is derricked with respect to the rotating platform 12, a hook 14 that is suspended from the boom 13 via a wire rope L, a detection device 16, such as a camera, that detects a swing of a suspended load H, an operation manipulation unit 20 that can be manipulated by an operator, an input/output unit 30 that outputs information to the operator and that inputs information from the operator, and a control unit 40 that performs operation control of the crane 1. The detection device 16 transmits detection information (video data or the like) on the swing of the suspended load H to the control unit 40 via an I/O 64.

Although FIG. 1 shows the lower structure 11 in a simplified manner, the lower structure 11 may be, for example, a traveling body such as a crawler, or may be a fixed structure. The rotating platform 12 has a main frame connected to the lower structure 11 via a bearing, and the crane 1 includes a turning device that turns via a bearing by using power from a hydraulic motor or the like. The boom 13 is pivotably connected to the main frame of the rotating platform 12, and the crane 1 includes a derricking winch that derricks the boom 13 by winding or unwinding a wire rope for derricking. The hook 14 is suspended from the boom 13 via the wire rope L, and the crane 1 includes a raising/lowering winch that raises and lowers the hook 14 by winding or unwinding the wire rope L. The operation manipulation unit 20, the input/output unit 30, and the control unit 40 may be disposed, for example, in a cab 2 and a control room 3 on the rotating platform 12.

With the above configuration, the crane 1 can suspend the suspended load H on the hook 14, wind the wire rope L to suspend the suspended load H, and then turn the rotating platform 12, and, as necessary, change a derricking angle of the boom 13, thereby moving the suspended load H to a position above a transport destination. Thereafter, the crane 1 can lower the suspended load H to the transport destination by unwinding the wire rope L. The turning of the rotating platform 12, the derricking of the boom 13, and the raising and lowering of the suspended load H are implemented by the control unit 40 outputting a turning request signal, a derricking request signal, and a raising/lowering request signal to a turning drive circuit 51 that drives a turning device of the rotating platform 12, a derricking drive circuit 52 that drives the derricking winch, and a raising/lowering drive circuit 53 that drives the raising/lowering winch, respectively, via an I/O 63. The turning drive circuit 51, the derricking drive circuit 52, and the raising/lowering drive circuit 53 will be collectively referred to as a drive circuit 50.

Although not particularly limited to this, the turning device turns the rotating platform 12 by receiving the power from the hydraulic motor that rotates with a pressure oil supplied from a hydraulic pump via a control valve. The turning drive circuit 51 operates the hydraulic motor by driving the above-described control valve, to drive or brake the turning device.

In addition, the derricking winch rotates a drum by receiving the power from the hydraulic motor that rotates with the pressure oil supplied from the hydraulic pump via the control valve, and winds the wire rope around the drum or unwinds the wire rope from the drum, to derrick the boom 13. The derricking drive circuit 52 operates the hydraulic motor by driving the above-described control valve, to drive the derricking winch. A height of a tip 13t of the boom 13 rises when the boom 13 is raised (the derricking angle is increased), and the height of the tip 13t of the boom 13 falls when the boom 13 is lowered (the derricking angle is decreased).

In addition, the raising/lowering winch rotates a drum by receiving the power from the hydraulic motor that rotates with the pressure oil supplied from the hydraulic pump via the control valve, and winds the wire rope around the drum or unwinds the wire rope from the drum, to raise and lower the hook 14. The raising/lowering drive circuit 53 operates the hydraulic motor by driving the above-described control valve, to drive the raising/lowering winch.

Hereinafter, the turning of the rotating platform 12 and the operation thereof will be simply referred to as “turning” and a “turning operation”, the derricking of the boom 13 and the operation thereof will be simply referred to as “derricking” and a “derricking operation”, and the raising and lowering of the suspended load H and the operation thereof will be simply referred to as “raising and lowering” and a “raising/lowering operation”. In addition, hereinafter, the derricking angle of the boom 13 is represented by 0 [rad] when horizontal and/2 [rad] when vertical, and an increase and a decrease in the derricking angle and increase and decrease rates of the derricking angle are represented.

The operation manipulation unit 20 includes an operation lever 21 for manually performing the turning operation, the derricking operation, and the raising/lowering operation, an automatic operation start manipulation unit 22 for a transition of the crane 1 to an automatic operation mode, and a swing suppression mode transition manipulation unit 23 for the transition to a swing suppression mode. The automatic operation mode is an operation mode in which information on the transport destination of the suspended load H is input in advance, and the turning operation and the derricking operation are automatically performed by manipulating the automatic operation start manipulation unit 22 in a state where the suspended load H is suspended, so that the suspended load H can be automatically moved to above the transport destination. The swing suppression mode is an operation mode in which a swing suppression operation of reducing the swing of the suspended load H is automatically performed. A manipulation signal of the operation lever 21, a manipulation signal of the automatic operation start manipulation unit 22, and a manipulation signal of the swing suppression mode transition manipulation unit 23 are transmitted to the control unit 40 via an I/O 61.

The input/output unit 30 includes a notification unit 31 that notifies the operator of information via display or sound, and a manipulation panel 32 through which the operator can input information via the manipulation. In addition, the control unit 40 includes an automatic operation setting processing unit 45 that inputs setting information (a movement start position of the suspended load H, a movement path of the boom 13, a movement end position of the suspended load H, and the like) on the automatic operation via the manipulation panel 32. The notification unit 31 receives a command from the control unit 40 via an I/O 62 to perform a notification operation. The manipulation panel 32 receives a display signal from the control unit 40 (more specifically, the automatic operation setting processing unit 45) via the I/O 62, and outputs a manipulation signal to the control unit 40 (more specifically, the automatic operation setting processing unit 45) via the I/O 62. There is a location where it is desired to avoid the passage of the boom 13 or to avoid the passage of the suspended load H and the wire rope L during the turning operation, and the information on the movement path of the boom 13 in the automatic operation may be set in a case where the passage can be avoided by changing the derricking angle of the boom 13. The information on the movement end position may have a format input by using position information, or may have a format input by using a turning angle of the rotating platform 12 and the derricking angle of the boom 13. Alternatively, a format may be adopted in which a position of the hook 14 is input as the movement end position by moving the hook 14 and performing a designation operation via a manual manipulation.

The control unit 40 includes a mode switching control unit 41 that performs switching control of the operation mode, a manual operation control unit 42 that performs operation control of the crane 1 in a manual operation mode, an automatic operation control unit 43 that performs the operation control of the crane 1 in the automatic operation mode, a swing suppression mode operation control unit 44 that performs the operation control of the crane 1 in the swing suppression mode, and the automatic operation setting processing unit 45 that inputs the setting information of the automatic operation via the manipulation panel 32. The control unit 40 is a computer including a central processing unit (CPU), a storage device that stores a control program, and an interface that inputs and outputs a signal between the control unit 40 and an external device (a component of the crane 1). The mode switching control unit 41, the manual operation control unit 42, the automatic operation control unit 43, the swing suppression mode operation control unit 44, and the automatic operation setting processing unit 45 may be software modules implemented by the CPU executing the control program. The control unit 40 exchanges commands and information with the operation manipulation unit 20, the input/output unit 30, the detection device 16, and the drive circuit 50 via a bus and the I/Os 61 to 63.

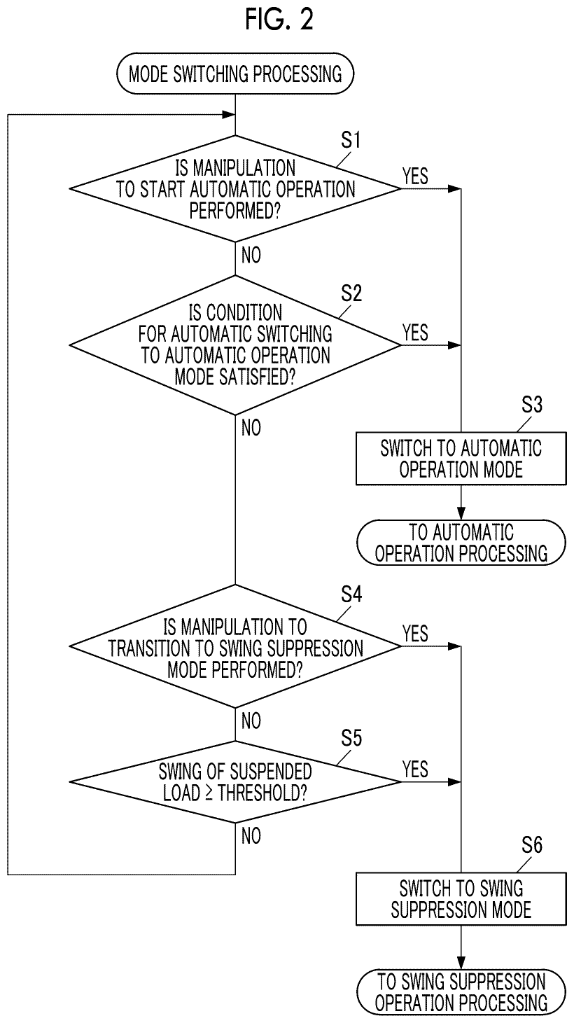

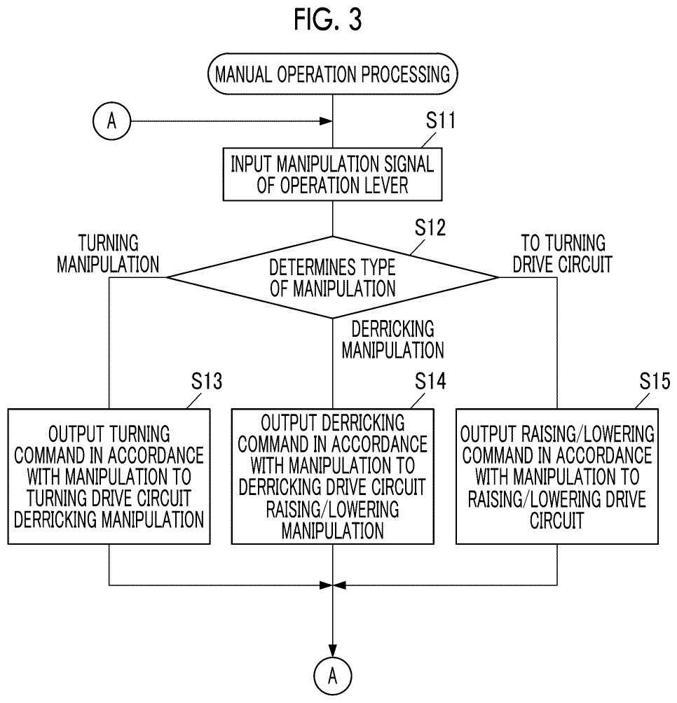

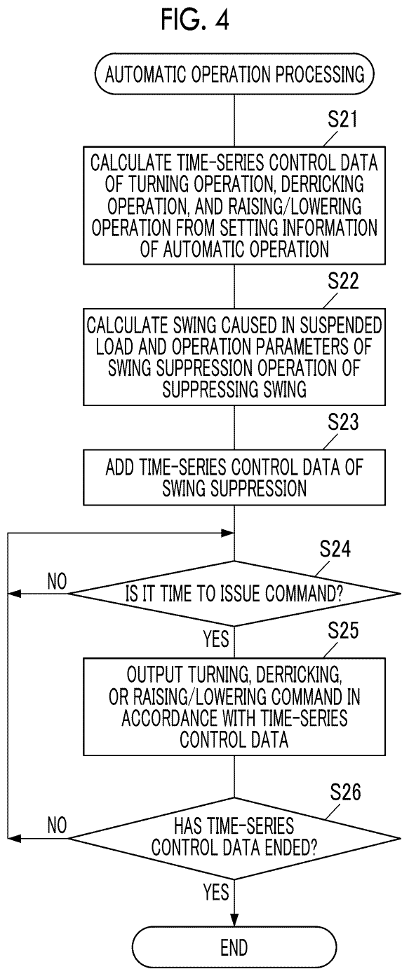

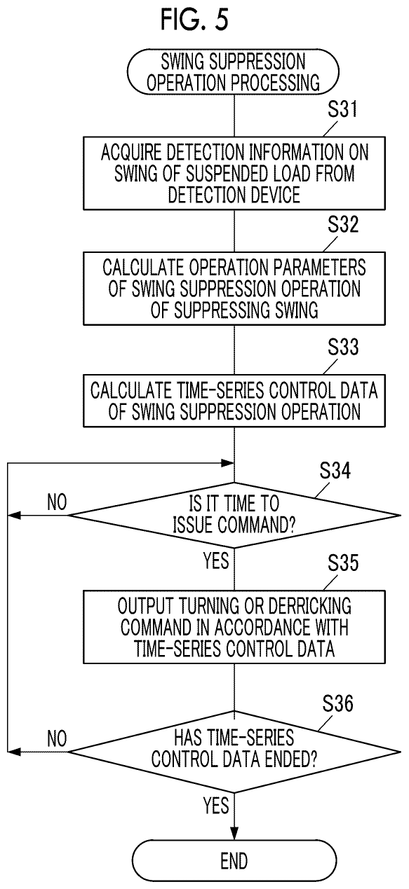

FIG. 2 is a flowchart showing mode switching processing executed by the mode switching control unit. FIG. 3 is a flowchart showing manual operation processing executed by the manual operation control unit. FIG. 4 is a flowchart showing automatic operation processing executed by the automatic operation control unit. FIG. 5 is a flowchart showing swing suppression operation processing executed by the swing suppression mode operation control unit. Subsequently, the functions of the respective control units of the control unit 40 will be described with reference to the flowcharts.

As shown in FIG. 2, in the manual operation mode, the mode switching control unit 41 executes loop processing including determination processing of steps S1, S2, S4, and S5. In the loop processing, the mode switching control unit 41 determines whether or not the operator performs manipulation (manipulation to start the automatic operation) of the automatic operation start manipulation unit 22 (step S1), and switches, when the manipulation is performed, the operation mode to the automatic operation mode (step S3). Further, the mode switching control unit 41 determines whether or not a predetermined condition for automatic switching to the automatic operation (for example, a condition in which a request for automatic switching to the automatic operation mode is issued, the suspended load is located at the movement start position of the automatic operation, and the operation is stopped) is satisfied (step S2), and switches, when the condition is satisfied, the operation mode to the automatic operation mode (step S3). The automatic operation control unit 43 operates by switching to the automatic operation mode.

Further, the mode switching control unit 41 determines whether or not the operator performs manipulation (manipulation to transition to the swing suppression mode) of the swing suppression mode transition manipulation unit 23 (step S4), and switches, when the manipulation is performed, the operation mode to the swing suppression mode (step S6). Further, the mode switching control unit 41 determines whether or not the swing of the suspended load H is equal to or greater than a predetermined threshold (step S5), and causes, when the swing is equal to or greater than the threshold, the operation mode to transition to the swing suppression mode (step S6). The determination of step S5 may be processing of not only determining a magnitude of the swing but also comprehensively determining various states of the swing of the suspended load H to determine whether or not it is preferable to perform the swing suppression. The detection information indicating the state (the magnitude and the like) of the swing of the suspended load H is input to the mode switching control unit 41 from the detection device 16. The swing suppression mode operation control unit 44 operates by switching to the swing suppression mode.

The mode switching control unit 41 may be configured to assist in the transition of the operation mode to the swing suppression mode based on the state of the swing of the suspended load H. The term “assist” means an operation of prompting the operator to transition to the swing suppression mode by, for example, issuing notification through the notification unit 31. Further, the mode switching control unit 41 may perform the transition of the operation mode to the swing suppression mode or assist in the transition of the operation mode based on a turning stop or turning deceleration during the manual operation (may be during the automatic operation in which the swing suppression operation is not performed).

As shown in FIG. 3, the manual operation control unit 42 inputs the manipulation signal of the operation lever 21 (step S11), determines a type of the manipulation of the operation lever 21 (step S12), and outputs, when the manipulation is a turning manipulation, a turning command corresponding to the manipulation to the turning drive circuit 51 (step S13). In addition, in a case of a derricking manipulation, a derricking command corresponding to the manipulation is output to the derricking drive circuit 52 (step S14). In addition, in a case of a raising/lowering manipulation, a raising/lowering command corresponding to the manipulation is output to the raising/lowering drive circuit 53 (step S15). Then, the manual operation control unit 42 returns the processing to step S11. The manual operation control unit 42 implements the turning operation, the derricking operation, and the raising/lowering operation in response to the manipulation of the operation lever 21 through the manual operation processing as described above.

The automatic operation control unit 43 performs the automatic operation including an automatic turning operation and an automatic derricking operation, based on the setting information of the automatic operation set via the automatic operation setting processing unit 45. The automatic operation may include an automatic raising/lowering operation. The automatic operation further includes a swing suppression operation of suppressing the swing of the suspended load H. The swing suppression operation here is an operation of suppressing the swing of the suspended load H at a final movement position of the suspended load H in the automatic operation, and includes an operation of accelerating and decelerating the turning and an operation of accelerating and decelerating the derricking. The automatic operation control unit 43 calculates the swing of the suspended load H caused by the automatic operation and operation parameters of the swing suppression operation of suppressing the swing, and includes the swing suppression operation having the calculated operation parameters in the automatic operation.

In detail, as shown in FIG. 4, the automatic operation control unit 43 calculates time-series control data for each operation of the turning operation, the derricking operation, and the raising/lowering operation from the setting information of the automatic operation (step S21). Further, the automatic operation control unit 43 calculates the swing caused in the suspended load H and the operation parameters of the swing suppression operation of suppressing the swing, from the time-series control data of the automatic operation calculated in step S21 (step S22). Then, time-series control data of the swing suppression operation to which the operation parameters of step S22 are applied is added to the time-series control data of the automatic operation calculated in step S21 (step S23). The calculations of steps S21 to S23 may be executed when the setting information of the automatic operation is set, instead of being executed in the automatic operation processing.

The automatic operation control unit 43 executes the automatic operation processing in accordance with the operation time-series control data generated in steps S21 and S23 in the loop processing of subsequent steps S24 to S26. That is, the automatic operation control unit 43 determines whether or not it is a time to issue the command (step S24), outputs, when it is the time to issue the command, the turning, derricking, or raising/lowering command in accordance with the time-series control data to the corresponding drive circuit (the turning drive circuit 51, the derricking drive circuit 52, or the raising/lowering drive circuit 53) (step S25), and determines whether or not the time-series control data has ended (step S26). The automatic operation control unit 43 repeats the processing of steps S24 to S26 until it is determined in step S26 that the time-series control data has ended. By such processing, the automatic operation including the swing suppression operation calculated in steps S21 to S23 is implemented.

The swing suppression mode operation control unit 44 performs the swing suppression operation of suppressing the swing of the suspended load H. The swing suppression operation here is an operation of suppressing the swing of the suspended load H that already exists when the transition to the swing suppression mode is performed, and includes an operation of accelerating and decelerating the turning and an operation of accelerating and decelerating the derricking. The operation mode before the transition to the swing suppression mode corresponds to a normal mode. As shown in FIG. 5, first, the swing suppression mode operation control unit 44 acquires the detection information (amplitudes and phases of the swing in two directions) of the detection device 16 indicating the state of the swing of the suspended load H (step S31). Next, the swing suppression mode operation control unit 44 calculates the operation parameters of the swing suppression operation of suppressing the swing of the suspended load H, based on the detection information (step S32), and calculates the time-series control data of the swing suppression operation to which the calculated operation parameters are applied (step S33). The swing suppression mode operation control unit 44 executes the processing of the swing suppression operation in accordance with the operation time-series control data generated in step S33 in the loop processing of subsequent steps S34 to S36. That is, the swing suppression mode operation control unit 44 determines whether or not it is a time to issue the command (step S34), outputs, when it is the time to issue the command, the turning or derricking command in accordance with the time-series control data to the corresponding drive circuit (the turning drive circuit 51 or the derricking drive circuit 52) (step S35), and determines whether or not the time-series control data has ended (step S36). The swing suppression mode operation control unit 44 repeats the processing of steps S34 to S36 until it is determined in step S36 that the time-series control data has ended. By such processing, the swing suppression operation calculated in step S33 is implemented, and the swing of the suspended load H is suppressed.

### AUTOMATIC OPERATION EXAMPLE 1

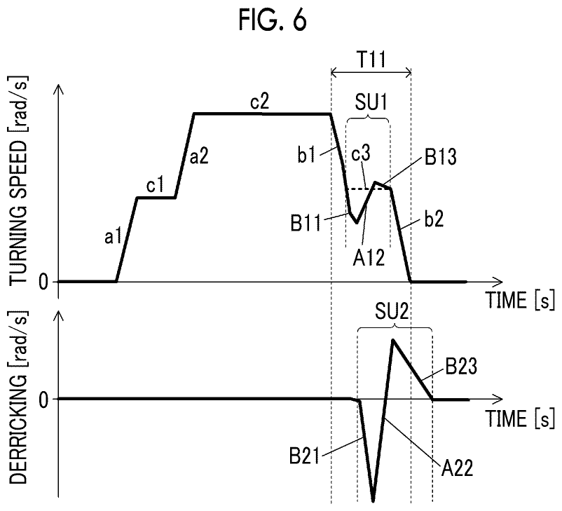

FIG. 6 is a time chart showing an automatic operation example 1 of the embodiment. FIG. 6 shows the automatic operation in a case where the suspended load H can be moved from the movement start position to the movement end position only by the turning operation.

In this case, when the swing suppression operation is not necessary, the suspended load H can be moved to the movement end position through accelerated turnings a1 and a2, constant-speed turnings c1, c2, and c3, and decelerated turnings b1 and b2. However, in such a movement, the turning movement of the suspended load H causes the swing in a turning direction q (see FIG. 1), and, at the same time, the centrifugal force generated in the suspended load H causes the swing in an orthogonal direction r (a horizontal direction perpendicular to the turning direction q, see FIG. 1). The swing in the turning direction q is represented by an angle θq in the turning direction q between a vertical line J passing through the tip of the boom 13 (a suspending position of the wire rope L) and the wire rope L, and the swing in the orthogonal direction r is represented by an angle θr in the orthogonal direction r between the vertical line J and the wire rope L. When the wire rope L is represented by a length 1, angular velocities ω and periods T of the swings θq and θr are functions of the length 1. The period T corresponds to a swing period that is a time for the reciprocating swing of the swings θq or θr.

As shown in FIG. 6, the automatic operation according to the embodiment includes a turning swing suppression operation SU1 of mainly suppressing the swing θq in the turning direction q and an orthogonal swing suppression operation SU2 of mainly suppressing the swing θr in the orthogonal direction r. The orthogonal swing suppression operation SU2 may be responsible for a part of the suppression effect of the swing θq in the turning direction q. The turning swing suppression operation SU1 may be responsible for a part of the suppression effect of the swing θr in the orthogonal direction r.

The turning swing suppression operation SU1 is an operation including, in time series, a decelerated turning B11, an accelerated turning A12, and a decelerated turning B13. The turning swing suppression operation SU1 may be performed during a turning deceleration period T11 of the automatic operation in a final stage of the automatic operation in which the suspended load H approaches the movement end position. The turning swing suppression operation SU1 may be an operation having a time length within one period of the swing. The turning swing suppression operation SU1 may be an operation in which the turning angle at a starting point and the turning angle at an ending point coincide with each other, or may be an operation in which the turning angle at the starting point and the turning angle at the ending point do not coincide with each other.

The orthogonal swing suppression operation SU2 is an operation of suppressing the suspended load H by increasing and decreasing the derricking angle of the boom 13, and includes, in time series, a derricking angle decrease B21, a derricking angle increase A22, and a derricking angle decrease B23. During a period of the orthogonal swing suppression operation SU2, the winding and unwinding of the wire rope L are not performed. The wire rope L may be wound, unwound, or wound and unwound during the period of the orthogonal swing suppression operation SU2. The orthogonal swing suppression operation SU2 may be performed in the final stage of the automatic operation in which the suspended load H approaches the movement end position, in the turning deceleration period T11 of the automatic operation, and in a period after the turning deceleration period T11. The orthogonal swing suppression operation SU2 may be an operation having a time length within one period of the swing. The orthogonal swing suppression operation SU2 may be an operation in which the derricking angle at a starting point and the derricking angle at an ending point coincide with each other, or may be an operation in which the derricking angle at the starting point and the derricking angle at the ending point do not coincide with each other. The operation in which the derricking angle at the starting point and the derricking angle at the ending point of the orthogonal swing suppression operation SU2 coincide with each other corresponds to an operation in which an increase amount and a decrease amount of the derricking angle during the orthogonal swing suppression operation are equal to each other. A case where the increase amount and the decrease amount of the derricking angle are equal to each other is not limited to only a case where the increase amount and the decrease amount of the derricking angle are strictly equal to each other, but also includes a case including an error. The error for which the increase amount and the decrease amount of the derricking angle can be regarded as being equal to each other is an amount at which a horizontal displacement amount of the hook 14 due to a difference in the derricking angle is equal to or less than a maximum horizontal width (for example, 50 cm) of the hook 14.

The automatic operation control unit 43 creates the time-series control data for implementing the turning operation and the derricking operation including the turning swing suppression operation SU1 and the orthogonal swing suppression operation SU2 as shown in the time chart of FIG. 6, based on the setting information of the automatic operation. Then, when a start condition of the automatic operation is satisfied, such as when the suspended load H is disposed at the movement start position, and the automatic operation start manipulation unit 22 is manipulated, the automatic operation control unit 43 executes the turning operation and the derricking operation in accordance with the time-series control data of the turning operation and the derricking operation.

In a case of the automatic operation in FIG. 6, the turning operation of the accelerated turning a1, the constant-speed turning c1, the accelerated turning a2, the constant-speed turning c2, and the decelerated turning b1 is performed, and the rotating platform 12 including the boom 13 turns, and the suspended load H moves in accordance with the turning. Due to such turning movement, the suspended load H generates the swing angles θq and θr in the turning direction q and the orthogonal direction r. Thereafter, when the turning swing suppression operation SU1 and the orthogonal swing suppression operation SU2 are executed, the swing θq in the turning direction q and the swing θr in the orthogonal direction r of the suspended load H are reduced by the acceleration or deceleration of the turning in the turning swing suppression operation SU1 and the increase or decrease of the derricking angle of the orthogonal swing suppression operation SU2. Then, the turning of the boom 13 and the rotating platform 12 is stopped in a state where the swing of the suspended load H is reduced through the subsequent decelerated turning b2. Then, the movement of the suspended load H to the movement end position is completed in a state where the swing is suppressed.

### Method of Calculating Operation Parameters of Turning Swing Suppression Operation

Subsequently, an example of a method of calculating the operation parameters for determining the turning swing suppression operation SU1 and the orthogonal swing suppression operation SU2 will be described. The magnitudes and the times of the decelerated turning B11, the accelerated turning A12, and the decelerated turning B13 in the turning swing suppression operation SU1 are obtained from the following algorithm. Here, the acceleration or deceleration of a tip position of the boom 13 corresponding to the decelerated turning B11, the accelerated turning A12, or the decelerated turning B13 is represented by b11, a12, or b13.

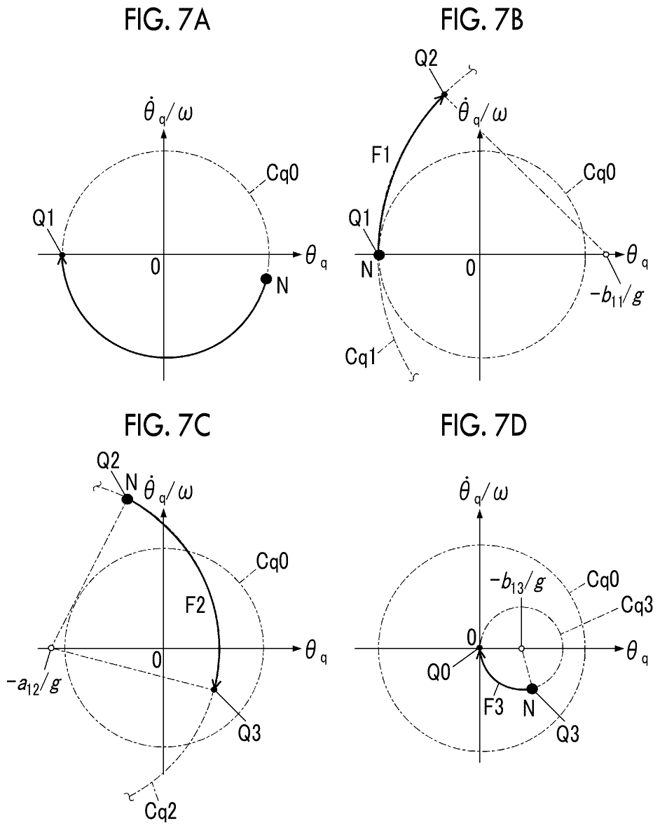

First, the principle will be described. As shown in FIG. 7A, the swing θq in the turning direction q can be represented as a circular motion of a phase point N shown on a predetermined phase plane (a horizontal axis represents the phase θq, and a vertical axis represents a standardized angular velocity “1/ω×dθq/dt (a time derivative is represented by a dot in the drawing)”). The circular motion of the phase point N revolves in the period T. When the tip of the boom 13 is stopped, the circular motion representing the swing θq is performed along a circle Cq0 centered on the origin of the phase plane. Meanwhile, when the acceleration or deceleration a in the same direction as the swing θq is applied to the tip of the boom 13, the center of the circular motion representing the swing θq is shifted to a point “vertical axis 0, horizontal axis (−a/g)” (g is the acceleration due to gravity) in accordance with the acceleration or deceleration.

As shown in FIGS. 7A and 7B, when the phase point N representing the swing moves along an initial circle Cq0, the acceleration or deceleration b11 is applied at a time when the phase point N comes to a predetermined point Q1 of the circle Cq0, whereby a center point of the circular motion on the phase plane is changed to a point −b11/g, and the circular motion of the phase point N representing the swing can be changed to a motion along a circle Cq1. Next, as shown in FIGS. 7B and 7C, when the phase point N representing the swing moves along the circle Cq1, the acceleration or deceleration a12 is applied at a time when the phase point N comes to a predetermined point Q2 of the circle Cq1, whereby the center point of the circular motion on the phase plane is changed to a point −a12/g, and the circular motion of the phase point N representing the swing can be changed to a motion along a circle Cq2. Similarly, as shown in FIGS. 7C and 7D, when the phase point N representing the swing moves along the circle Cq2, the acceleration or deceleration b13 is applied at a time when the phase point N comes to a predetermined point Q3 of the circle Cq2, whereby the center point of the circular motion on the phase plane is changed to a point −b13/g, and the circular motion of the phase point N representing the swing can be changed to a circle Cq3 passing through the origin. When the phase point N representing the swing is moved along the circle Cq3, the acceleration or deceleration is set to zero at a time when the phase point N comes to the origin, whereby the phase point N representing the swing stops at the origin, and the swing θq of the suspended load H can be set to zero.

The automatic operation control unit 43 uses the algorithm in accordance with the above-described principle to decrease the swing θq in the turning direction q or make the swing θq in the turning direction q substantially zero, and calculates the acceleration or deceleration b11, a12, and b13 and the turning acceleration or deceleration B11, A12, and B13 converted from the acceleration or deceleration b11, a12, and b13, and the times when the phase point N comes to the predetermined points Q1, Q2, Q3, and Q0. The automatic operation control unit 43 uses these calculation results as the operation parameters of the turning swing suppression operation SU1. The operation parameters still have degrees of freedom, and the automatic operation control unit 43 may calculate the above-described operation parameters by using the degrees of freedom such that the turning angle at the starting point and the turning angle at the ending point of the turning swing suppression operation SU1 coincide with each other.

### Method of Calculating Operation Parameters of Orthogonal Swing Suppression Operation

The magnitudes and the times of the derricking angle decrease B21, the derricking angle increase A22, and the derricking angle decrease B23 in the orthogonal swing suppression operation SU2 are obtained from the algorithm in accordance with the same principle as described above. Here, the acceleration or deceleration, in the orthogonal direction r, of the tip position of the boom 13 corresponding to the derricking angle decrease B21, the derricking angle increase A22, or the derricking angle decrease B23 is represented by b21, a22, or b23.

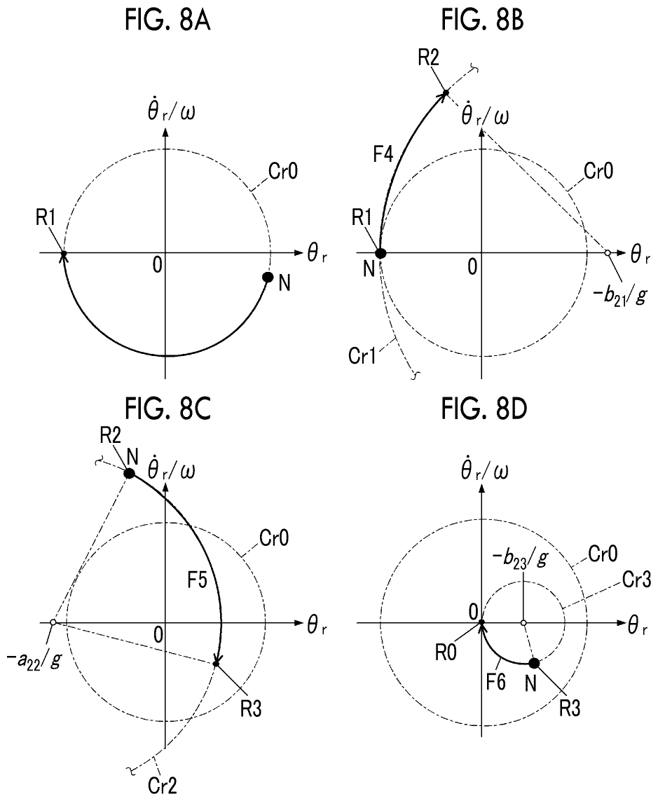

First, the principle will be described. As shown in FIG. 8A, the swing θr in the orthogonal direction r can be represented as a circular motion of a phase point N shown on a predetermined phase plane (a horizontal axis represents the phase θr, and a vertical axis represents a standardized angular velocity “1/ω×dθr/dt (a time derivative is represented by a dot in the drawing)”). The circular motion of the phase point N revolves in the period T. When the tip of the boom 13 is stopped, the circular motion representing the swing θr is performed along a circle Cr0 centered on the origin of the phase plane. Meanwhile, when the acceleration or deceleration a in the same direction as the swing θr is applied to the tip of the boom 13, the center of the circular motion representing the swing θr is shifted to a point “vertical axis 0, horizontal axis (−a/g)” (g is the acceleration due to gravity) in accordance with the acceleration or deceleration.

As shown in FIGS. 8A and 8B, when the phase point N representing the swing moves along an initial circle Cr0, the deceleration b21 is applied at a time when the phase point N comes to a predetermined point R1 of the circle Cr0, whereby a center point of the circular motion on the phase plane is changed to a point-b21/g, and the circular motion of the phase point N representing the swing can be changed to a motion along a circle Cr1. Next, as shown in FIGS. 8B and 8C, when the phase point N representing the swing moves along the circle Cr1, the acceleration a22 is applied at a time when the phase point N comes to a predetermined point R2 of the circle Cr1, whereby the center point of the circular motion on the phase plane is changed to a point-a22/g, and the circular motion of the phase point N representing the swing can be changed to a motion along a circle Cr2. Similarly, as shown in FIGS. 8C and 8D, when the phase point N representing the swing moves along the circle Cr2, the deceleration b23 is applied at a time when the phase point N comes to a predetermined point R3 of the circle Cr2, whereby the center point of the circular motion on the phase plane is changed to a point-b23/g, and the circular motion of the phase point N representing the swing can be changed to a circle Cr3 passing through the origin. When the phase point N representing the swing is moved along the circle Cr3, the acceleration or deceleration is set to zero at a time when the phase point N comes to the origin, whereby the phase point N representing the swing stops at the origin, and the swing θr of the suspended load H can be set to zero.

The automatic operation control unit 43 uses the algorithm in accordance with the above-described principle to decrease the swing θr in the orthogonal direction r or make the swing θr in the orthogonal direction r substantially zero, and calculates the acceleration or deceleration b21, a22, and b23 and the derricking acceleration B21, A22, and B23 converted from the acceleration or deceleration b21, a22, and b23, and the times when the phase point N comes to the predetermined points R1, R2, R3, and R0. The operation parameters still have degrees of freedom, and the automatic operation control unit 43 may calculate the above-described operation parameters by using the degrees of freedom such that the derricking angle at the starting point and the derricking angle at the ending point of the orthogonal swing suppression operation SU2 coincide with each other. The automatic operation control unit 43 uses these calculation results as the operation parameters of the orthogonal swing suppression operation SU2.

The above-described calculation methods of the operation parameters of the turning swing suppression operation SU1 and the orthogonal swing suppression operation SU2 are merely examples. The automatic operation control unit 43 may perform a correction including various elements that affect the swing of the suspended load H, such as wind, the weight of the wire rope L, and a change in the turning direction q and the orthogonal direction r due to the turning, in the calculation using the above-described algorithm, to calculate the above-described operation parameters. Alternatively, the automatic operation control unit 43 may calculate the operation parameters for determining the turning swing suppression operation SU1 and the orthogonal swing suppression operation SU2 by using another algorithm, or may acquire such operation parameters through machine learning.

### SIMULATION RESULT OF AUTOMATIC OPERATION EXAMPLE ₁

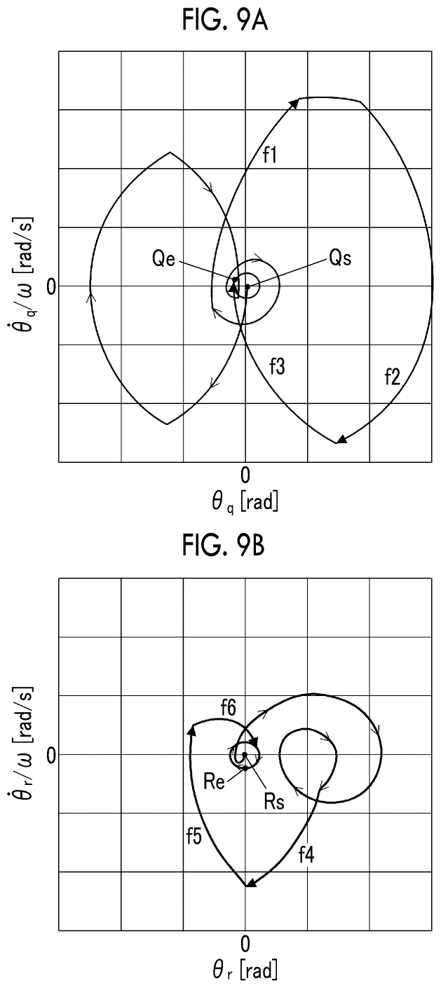

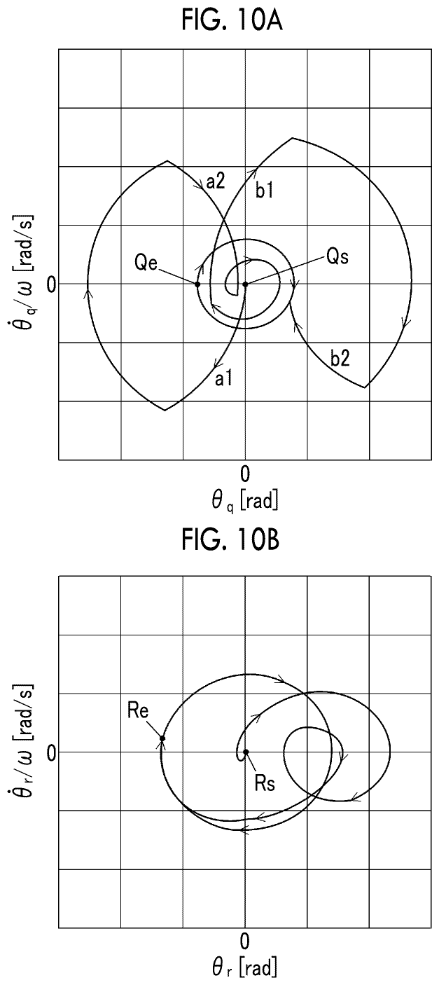

FIG. 9A is a diagram showing, in the phase plane, a simulation result of the swing θq in the turning direction q in the automatic operation example 1, and FIG. 9B is a diagram showing, in the phase plane, a simulation result of the swing θr in the orthogonal direction r in the automatic operation example 1. FIGS. 10A and 10B are diagrams showing, in the phase plane, simulation results of the swings θq and θr during the automatic operation in which the swing suppression is not performed. In the drawings, points Qe and Rs indicate phase points at the starting point of the automatic operation, and points Qe and Re indicate phase points at the ending point of the automatic operation.

According to the automatic operation example 1 shown in FIG. 6, the suspended load H can be moved to the movement end position by the turning operation, and further, the swing of the suspended load H is suppressed at the movement end position by the turning swing suppression operation SU1 and the orthogonal swing suppression operation SU2. As shown in FIGS. 9A and 9B, as a result of the operation of the automatic operation example 1, both the swings θq and θr in the turning direction q and the orthogonal direction r are suppressed. Arrow curves F1 to F3 in FIG. 9A are changes in the phase point due to the turning swing suppression operation SU1, and correspond to arrow curves f1 to f3 shown in FIGS. 7B to 7D for the description of the principle. Arrow curves F4 to F6 in FIG. 9B are changes in the phase point due to the orthogonal swing suppression operation SU2, and correspond to arrow curves f4 to f6 shown in FIGS. 8B to 8D for the description of the principle.

Meanwhile, as shown in FIGS. 10A and 10B, when the turning swing suppression operation SU1 and the orthogonal swing suppression operation SU2 of the automatic operation example 1 are not performed, in the swing θq in the turning direction q, the phase point is greatly changed in the accelerated turning a1 and a2 and the decelerated turning b1 and b2, and the phase point Qe at the ending point does not approach the zero point, so that the residual swing is increased. In addition, in the swing θr in the orthogonal direction r, the amplitude gradually deviates due to the centrifugal force, and the phase point Re at the ending point does not approach the zero point, so that the residual swing is increased.

### AUTOMATIC OPERATION EXAMPLE 2

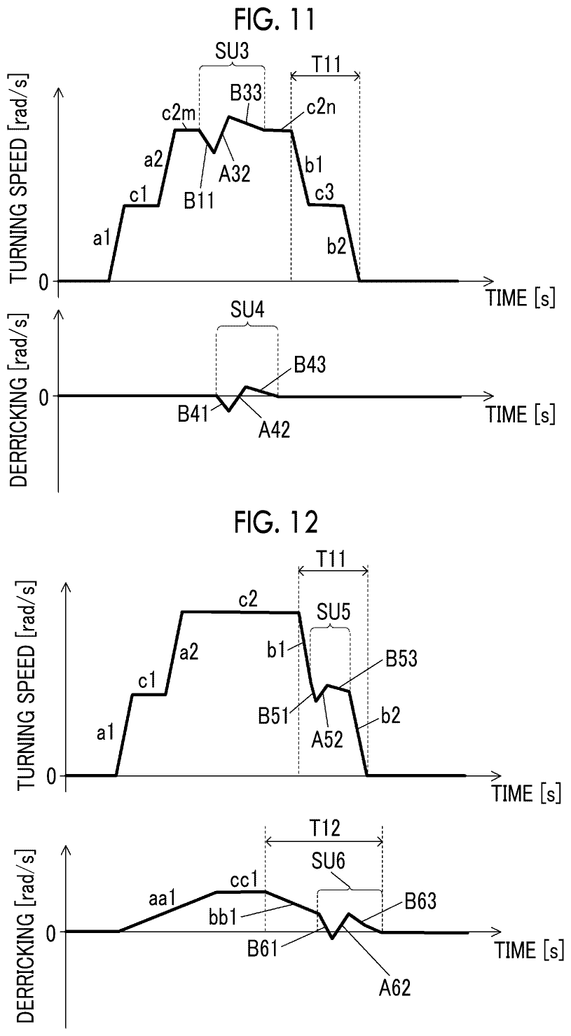

FIG. 11 is a time chart showing an automatic operation example 2 of the embodiment. The automatic operation example 2 is the automatic operation in a case where the suspended load H can be moved from the movement start position to the movement end position only by the turning operation, as in the automatic operation example 1, and is an example in which an execution time of a turning swing suppression operation SU3 and an orthogonal swing suppression operation SU4 is changed from the automatic operation example 1.

As shown in FIG. 11, the automatic operation control unit 43 may execute the turning swing suppression operation SU3 and the orthogonal swing suppression operation SU4 during the turning of the automatic operation, more specifically, between constant-speed turning c2m and d2n in a middle stage of the automatic operation. In addition, the automatic operation control unit 43 may execute the turning swing suppression operation SU3 and the orthogonal swing suppression operation SU4 during a decelerated turning in the middle stage of the automatic operation, during an accelerated turning in an early stage of the automatic operation, or the like. In addition, the automatic operation control unit 43 may execute the operations at different times without performing the turning swing suppression operation SU3 and the orthogonal swing suppression operation SU4 at the same time.

The turning swing suppression operation SU3 is an operation including, in time series, a decelerated turning B31, an accelerated turning A32, and a decelerated turning B33. The turning swing suppression operation SU3 may be an operation having a time length within one period of the swing. The turning swing suppression operation SU3 may be an operation in which the turning angle at a starting point and the turning angle at an ending point coincide with each other, or may be an operation in which the turning angle at the starting point and the turning angle at the ending point do not coincide with each other.

The orthogonal swing suppression operation SU4 is an operation of suppressing the suspended load H by increasing and decreasing the derricking angle of the boom 13, and includes, in time series, a derricking angle decrease B41, a derricking angle increase A42, and a derricking angle decrease B43. During a period of the orthogonal swing suppression operation SU4, the winding and unwinding of the wire rope L are not performed. However, the winding and unwinding of the wire rope L may be used in combination. The orthogonal swing suppression operation SU4 may be an operation having a time length within one period of the swing. The orthogonal swing suppression operation SU4 may be an operation in which the derricking angle at a starting point and the derricking angle at an ending point coincide with each other, or may be an operation in which the derricking angle at the starting point and the derricking angle at the ending point do not coincide with each other.

The automatic operation control unit 43 creates the time-series control data for implementing the turning operation and the derricking operation including the turning swing suppression operation SU3 and the orthogonal swing suppression operation SU4 as shown in the time chart of FIG. 11, based on the setting information of the automatic operation. Then, when a start condition of the automatic operation is satisfied, such as when the suspended load H is disposed at the movement start position, and the automatic operation start manipulation unit 22 is manipulated, the automatic operation control unit 43 executes the turning operation and the derricking operation in accordance with the time-series control data of the turning operation and the derricking operation.

In a case of the automatic operation in FIG. 11, the turning operation of the accelerated turning a1, the constant-speed turning c1, the accelerated turning a2, and the constant-speed turning c2m is performed, and the rotating platform 12 including the boom 13 turns, and the suspended load H moves in accordance with the turning. Due to such turning movement, the suspended load H generates the swing angles θq and θr in the turning direction q and the orthogonal direction r. Thereafter, when the turning swing suppression operation SU3 and the orthogonal swing suppression operation SU4 are executed, the swing Oq in the turning direction q of the suspended load H is changed by the turning swing suppression operation SU3. Further, the swing θr in the orthogonal direction r is changed by the orthogonal swing suppression operation SU4. Further, when a constant-speed turning c2n, the decelerated turning b1, the constant-speed turning c3, and the decelerated turning b2 are performed thereafter, the effect of the swing is added to the suspended load H by these turnings. The above-described effect is added to the swings θq and θr changed by executing the turning swing suppression operation SU3 and the orthogonal swing suppression operation SU4, whereby the swing of the suspended load H is finally reduced. Then, the turning of the boom 13 and the rotating platform 12 is stopped, and the movement of the suspended load H to the movement end position is completed in a state where the swing is suppressed.

### Method of Calculating Operation Parameters of Swing Suppression Operation

In a case where the turning swing suppression operation SU3 is performed during the turning of the automatic operation (for example, the early stage or the middle stage of the automatic operation), the automatic operation control unit 43 calculates the operation parameters of the turning swing suppression operation SU3 by using the algorithm in accordance with the above-described principle such that the swing is suppressed at the ending point of the automatic operation, including the effect of the swing q in the turning direction q caused by the turning operation after the turning swing suppression operation SU3.

Similarly, in a case where the orthogonal swing suppression operation SU4 is performed during the turning of the automatic operation (for example, the early stage or the middle stage of the automatic operation), the automatic operation control unit 43 calculates the operation parameters of the orthogonal swing suppression operation SU4 by performing the calculation using the above-described algorithm such that the swing is suppressed at the ending point of the automatic operation, including the effect of the centrifugal force of the turning operation on the swing θr in the orthogonal direction r after the orthogonal swing suppression operation SU4.

Further, in a case where the turning angle at which the turning swing suppression operation SU3 and the orthogonal swing suppression operation SU4 are performed is significantly different from the turning angle at the movement end position, the turning direction q during the swing suppression operation is a direction including a component in the turning direction q and a component in the orthogonal direction r at the time of the end of the automatic operation. Similarly, the orthogonal direction r during the swing suppression operation is a direction including a component in the turning direction q and a component in the orthogonal direction r at the time of the end of the automatic operation. Therefore, the turning swing suppression operation SU3 acts on both the swing θq in the turning direction q and the swing θr in the orthogonal direction r at the ending point of the automatic operation, and the orthogonal swing suppression operation SU4 acts on both the swing θq in the turning direction q and the swing θr in the orthogonal direction r at the ending point of the automatic operation. Therefore, in such a case, the automatic operation control unit 43 need only determine the operation parameters of the turning swing suppression operation SU3 and the orthogonal swing suppression operation SU4 such that an amount by which both the turning swing suppression operation SU3 and the orthogonal swing suppression operation SU4 act on the swing θq in the turning direction q at the ending point of the automatic operation and an amount by which the automatic operation after the swing suppression operation acts on the swing θq in the turning direction q at the ending point of the automatic operation are combined to suppress the swing θq in the turning direction q. In addition, the automatic operation control unit 43 need only determine the operation parameters of the turning swing suppression operation SU3 and the orthogonal swing suppression operation SU4 such that an amount by which both the turning swing suppression operation SU3 and the orthogonal swing suppression operation SU4 act on the swing θr in the orthogonal direction r at the ending point of the automatic operation and an amount by which the automatic operation after the swing suppression operation acts on the swing θr in the orthogonal direction r at the ending point of the automatic operation are combined to suppress the swing θr in the orthogonal direction r. The turning swing suppression operation SU3 and the orthogonal swing suppression operation SU4 calculated in this way can suppress the swing of the suspended load H at the time of the end of the automatic operation even when the early stage or the middle stage of the automatic operation is set as the execution time of the swing suppression operation.

### AUTOMATIC OPERATION EXAMPLE 3

FIG. 12 is a time chart showing an automatic operation example 3 of the embodiment. The automatic operation example 3 is an automatic operation including a derricking operation of changing a movement radius of the suspended load H. For example, in a case where the derricking angle of the boom 13 is different between the movement start position and the movement end position of the suspended load H, or in a case where there is a need to change the derricking angle of the boom 13 due to a constraint on the movement path of the boom 13 or the suspended load H during a process of the movement, the automatic operation of changing the movement radius of the suspended load H is adopted. In such an automatic operation, in addition to the turning operation including the accelerated turnings a1 and a2, the constant-speed turnings c1, c2, and c3, and the decelerated turnings b1 and b2, which are the same as those in the automatic operation example 1 and the automatic operation example 2, the derricking operation including a derricking angle increase aal, a constant-speed derricking cc1, and a derricking angle decrease bb1 is included.

The automatic operation control unit 43 performs a turning swing suppression operation SU5 and an orthogonal swing suppression operation SU6 during the automatic operation as described above. In the example of FIG. 12, the automatic operation control unit 43 performs the turning swing suppression operation SU5 and the orthogonal swing suppression operation SU6 in the final stage of the automatic operation, more specifically, in the turning deceleration period T11 and a derricking deceleration period T12. However, as shown in the automatic operation example 2, the automatic operation control unit 43 may perform the turning swing suppression operation SU5 and the orthogonal swing suppression operation SU6 in the early stage, the middle stage, or the like of the automatic operation. In addition, the automatic operation control unit 43 may execute the operations at different times without performing the turning swing suppression operation SU5 and the orthogonal swing suppression operation SU6 at the same time.

The turning swing suppression operation SU5 is calculated in the same manner as the turning swing suppression operation SU1 shown in the automatic operation example 1.

The orthogonal swing suppression operation SU6 is an operation of suppressing the suspended load H by increasing and decreasing the derricking angle of the boom 13, and includes, in time series, a derricking angle decrease B61, a derricking angle increase A62, and a derricking angle decrease B63. During a period of the orthogonal swing suppression operation SU6, the winding and unwinding of the wire rope L are not performed. However, the winding and unwinding of the wire rope L may be used in combination. The orthogonal swing suppression operation SU6 may be an operation having a time length within one period of the swing. The orthogonal swing suppression operation SU6 may be an operation in which the derricking angle at a starting point and the derricking angle at an ending point coincide with each other, or may be an operation in which the derricking angle at the starting point and the derricking angle at the ending point do not coincide with each other. The derricking angle decreases B61 and B63 and the derricking angle increase A62 in the orthogonal swing suppression operation SU6 may be accelerated or decelerated more rapidly than the acceleration or deceleration of the derricking angle increase aal and the derricking angle decrease bb1 in the other periods during the automatic operation.

The automatic operation control unit 43 creates the time-series control data for implementing the turning operation and the derricking operation including the turning swing suppression operation SU5 and the orthogonal swing suppression operation SU6 as shown in the time chart of FIG. 12, based on the setting information of the automatic operation. Then, when a start condition of the automatic operation is satisfied, such as when the suspended load H is disposed at the movement start position, and the automatic operation start manipulation unit 22 is manipulated, the automatic operation control unit 43 executes the turning operation and the derricking operation in accordance with the time-series control data of the turning operation and the derricking operation. By such an automatic operation, the turning angle and the derricking angle are changed, and the suspended load H is moved to the movement end position, and further, the turning swing suppression operation SU5 and the orthogonal swing suppression operation SU6 are performed, so that the swing of the suspended load H is suppressed at the movement end position.

### Operation Example of Swing Suppression Mode

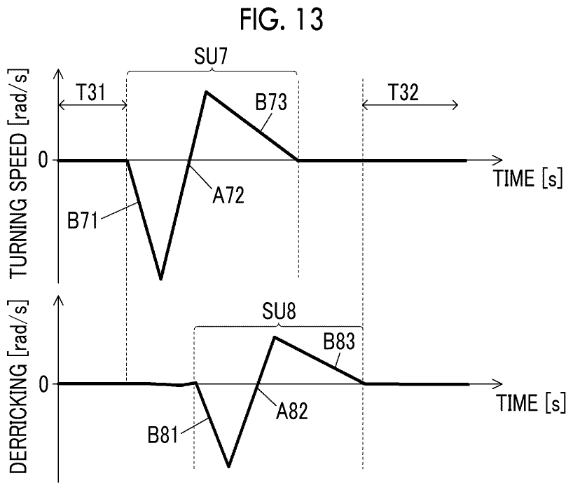

FIG. 13 is a time chart showing an operation example of the swing suppression mode.

When the transition to the swing suppression mode is performed, the swing suppression mode operation control unit 44 performs, for example, a turning swing suppression operation SU7 and an orthogonal swing suppression operation SU8 as shown in FIG. 13. In a case where, after the suspended load H is manually moved, the swing suppression mode transition manipulation unit 23 is manipulated to perform the transition to the swing suppression mode in order to suppress the swing of the suspended load H, periods T31 and T32 in which the turning and the derricking are stopped are included immediately before and after the swing suppression operation (the turning swing suppression operation SU7 and the orthogonal swing suppression operation SU8). In addition, even when the swing of the suspended load H is increased during the movement of the suspended load H, and the mode switching control unit 41 automatically performs the transition to the swing suppression mode, the periods T31 and T32 in which the turning and the derricking are stopped may be included immediately before, immediately after, or both immediately before and immediately after the swing suppression operation (the turning swing suppression operation SU7 and the orthogonal swing suppression operation SU8).

The swing suppression mode operation control unit 44 may acquire the swings θq and θr of the suspended load H before the swing suppression operation and information on the phases of the swings, for example, based on the detection information indicating the state of the swing of the suspended load H detected by the detection device 16 in the period T31. The swing suppression mode operation control unit 44 calculates the operation parameters of the turning swing suppression operation SU7 and the orthogonal swing suppression operation SU8 based on the principle and the algorithm described in the automatic operation example 1. Then, the swing suppression mode operation control unit 44 executes the turning operation and the derricking operation in accordance with the time-series control data to which the operation parameters are applied.

The turning swing suppression operation SU7 is an operation including, in time series, a decelerated turning B71, an accelerated turning A72, and a decelerated turning B73. The turning swing suppression operation SU7 may be an operation having a time length within one period of the swing. The turning swing suppression operation SU7 is an operation in which the turning angle at a starting point and the turning angle at an ending point coincide with each other, or may be an operation in which the turning angle at the starting point and the turning angle at the ending point do not coincide with each other.

The orthogonal swing suppression operation SU8 is an operation of suppressing the suspended load H by increasing and decreasing the derricking angle of the boom 13, and includes, in time series, a derricking angle decrease B81, a derricking angle increase A82, and a derricking angle decrease B83. During a period of the orthogonal swing suppression operation SU8, the winding and unwinding of the wire rope L are not performed. However, the winding and unwinding of the wire rope L may be used in combination. The orthogonal swing suppression operation SU8 may be an operation having a time length within one period of the swing. The orthogonal swing suppression operation SU8 is an operation in which the derricking angle at a starting point and the derricking angle at an ending point coincide with each other, but may be an operation in which the derricking angle at the starting point and the derricking angle at the ending point do not coincide with each other.

### Simulation Result of Swing Suppression Mode

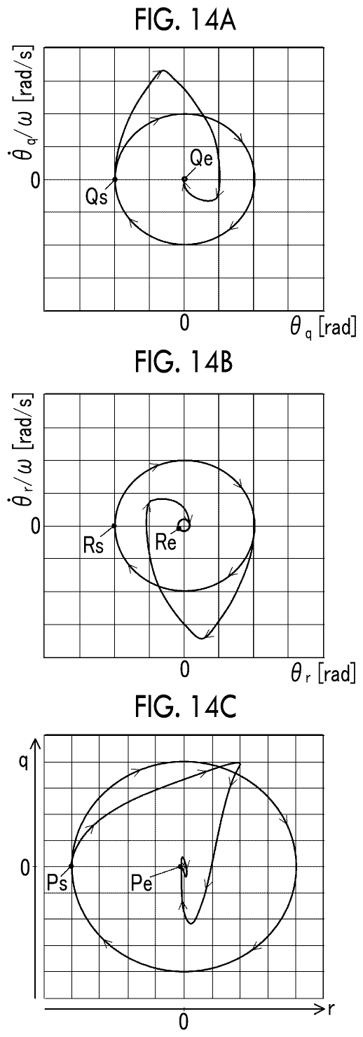

FIGS. 14A to 14C are a phase plane trajectory diagram in the turning direction q, a phase plane trajectory diagram in the orthogonal direction r, and a trajectory diagram of the suspended load, respectively, the phase plane trajectory diagrams showing a simulation result in the swing suppression mode. Points Qs, Rs, and Ps indicate respective phase points and trajectory points before the swing suppression operation, and points Qe, Re, and Pe indicate respective phase points and trajectory points after the swing suppression operation. As a result of the operation in the swing suppression mode of FIG. 13, both the swings θq and θr in the turning direction q and in the orthogonal direction r are suppressed as shown in FIGS. 14A to 14C.

As described above, with the crane 1 according to the present embodiment, the swing of the suspended load H is suppressed by the orthogonal swing suppression operations SU2, SU4, and SU6 in which the derricking angle of the boom 13 is increased and decreased when the rotating platform 12 turns to move the suspended load H during the automatic operation. With such a swing suppression operation, it is not necessary to wind or unwind the wire rope L, and it is possible to suppress the swing θr in the orthogonal direction r caused by the turning operation, without changing the swing period of the suspended load H. Since the swing period is not changed, the swing suppression is easily controlled, and the operator can easily predict the trajectory of the suspended load H. However, the swing period may be changed.

Further, with the crane 1 according to the present embodiment, as shown in the automatic operation example 3, in a case where the derricking operation (the derricking angle increase aal, the constant-speed derricking cc1, and the derricking angle decrease bb1) of changing the movement radius of the suspended load H is included in the automatic operation, the derricking angle increase A62 and the derricking angle decreases B61 and B63 included in the orthogonal swing suppression operation SU6 (the increase and the decrease in the derricking angle for the swing suppression) have a larger increase rate or decrease rate than the derricking angle increase aal and the derricking angle decrease bb1 included in the derricking operation. With such an automatic operation, the speed at which the swing of the suspended load H is increased can be slowed down by the derricking operation for changing the movement radius. Further, the swing of the suspended load H can be quickly suppressed during the swing suppression operation.

Further, with the crane 1 according to the present embodiment, the time of the orthogonal swing suppression operations SU2, SU4, SU6, and SU8 is shorter than the swing period. Therefore, a time during which a large swing continues after the swing suppression operation is started can be shortened.

Further, with the crane 1 according to the present embodiment, the increase amount and the decrease amount of the derricking angle in the orthogonal swing suppression operations SU2, SU4, SU6, and SU8 are equal to each other. Therefore, it is possible to suppress the change in the derricking angle of the boom 13 before and after the swing suppression operation, and it is possible to suppress the change in the movement radius of the suspended load H during the automatic operation, via the swing suppression operation.

Further, with the crane 1 according to the present embodiment, as shown in the automatic operation example 1 and the automatic operation example 3, the orthogonal swing suppression operations SU2 and SU6 are performed in the turning deceleration period T11 of the automatic operation and a subsequent period. Therefore, since the operation that causes the swing in the suspended load H does not continue for a long time after the orthogonal swing suppression operations SU2 and SU6, the swing of the suspended load H at the movement end position in the automatic operation can be further reduced. In a case where the swing suppression operation is performed in the turning deceleration period T11, it is possible to achieve the effect that derricking up and down for the swing suppression can be performed while the boom 13 is moving.

Further, with the crane 1 according to the present embodiment, the swing suppression mode operation control unit 44 increases and decreases the derricking angle of the boom 13 to suppress the suspended load H in the swing suppression mode. Therefore, in a case where the swing suppression mode is activated, it is possible to respond to the request at various times when the swing suppression in the orthogonal direction r is required.

Further, the crane 1 according to the present embodiment includes the detection device 16 that detects the swing of the suspended load H, and the mode switching control unit 41 performs the transition to the swing suppression mode or assists in the transition to the swing suppression mode, based on the detection information of the detection device 16 indicating the state of the swing of the suspended load H. With such a configuration, in a case where the swing of the suspended load H becomes large, it is possible to perform the transition to the swing suppression mode and suppress the swing.

Further, with the crane 1 according to the present embodiment, the mode switching control unit 41 performs the transition to the swing suppression mode or assists in the transition to the swing suppression mode, based on the stop or the deceleration of the turning of the rotating platform 12. A period during which the turning is stopped or decelerated is often the final stage of the movement of the suspended load H, and the degree of requirement for suppressing the swing is high in order to lower the suspended load H in the final stage of the movement. Therefore, according to the above-described configuration, it is possible to satisfy the requirement for suppressing the swing at the final stage of the movement of the suspended load H. The mode switching control unit 41 may determine the stop or the deceleration of the turning, based on the manipulation signal of the operation lever 21 or on the movement of the rotating platform 12.

The embodiment of the present invention has been described above. However, the present invention is not limited to the above-described embodiment. For example, in the above-described embodiment, a configuration has been described in which the swing suppression operation of increasing and decreasing the derricking angle of the boom is performed only once during the automatic operation. However, for example, the swing suppression operation may be performed a plurality of times at a plurality of timings during the automatic operation, such as the middle stage and the final stage. In a case where the swing suppression operation is performed a plurality of times, the swing suppression operation other than the last swing suppression operation may be an operation of suppressing the swing θr at that time. In addition, in the above-described embodiment, the operation example including, in time series, the derricking angle decrease, the derricking angle increase, and the derricking angle decrease has been described as the swing suppression operation of increasing and decreasing the derricking angle of the boom, but, for example, an operation including, in time series, the derricking angle increase, the derricking angle decrease, and the derricking angle increase may be adopted, or the swing suppression operation may be configured by combining the derricking angle increase and the derricking angle decrease in which the acceleration or deceleration amount is changed continuously over time, instead of switching between constant acceleration and deceleration derricking. In addition, the orthogonal swing suppression operations SU2 and SU8 as shown in FIGS. 6 and 13 may be divided into two operations at the time when the derricking speed is zero, and the operation in the first half and the operation in the second half may be performed with a time interval. In addition, in the above-described embodiment, the example has been described in which the orthogonal swing suppression operation and the turning swing suppression operation are combined, but the orthogonal swing suppression operation may be performed without performing the turning swing operation when the turning swing suppression operation is not necessary.

In addition, in the above-described embodiment, the crane including one boom that is capable of being derricked with respect to the rotating platform has been described, but the crane according to the present invention may be a crane including a first boom (for example, a tower boom) that is pivotably connected to the rotating platform and a second boom (for example, a jib) that is pivotably connected to the first boom. In this case, the derricking angle of the first boom, the derricking angle of the second boom, or the derricking angles of both the first boom and the second boom may be increased and decreased to perform the operation of suppressing the swing of the suspended load. In addition, the crane according to the present invention may be any crane as long as the crane includes a rotating platform and is capable of being derricked, such as a wheel crane, a truck crane, a jib crane, and a tower crane. In addition, the details shown in the embodiment can be modified as appropriate without departing from the scope of the invention.

It should be understood that the invention is not limited to the above-described embodiment, but may be modified into various forms on the basis of the spirit of the invention. Additionally, the modifications are included in the scope of the invention.

What is claimed is:

1. A crane comprising:
a rotating platform; and
a boom capable of being derricked with respect to the rotating platform,
wherein the crane automatically increases and decreases a derricking angle of the boom to suppress a swing of a suspended load when the rotating platform turns to move the suspended load.

2. The crane according to claim 1,
wherein, during an automatic operation in which the rotating platform turns to move the suspended load, the crane automatically increases and decreases the derricking angle of the boom to suppress the swing of the suspended load.

3. The crane according to claim 2,
wherein the automatic operation includes a derricking operation for changing a movement radius of the suspended load, and
an increase in the derricking angle for suppressing the swing has a larger increase rate than an increase in the derricking angle included in the derricking operation, or a decrease in the derricking angle for suppressing the swing has a larger decrease rate than a decrease in the derricking angle included in the derricking operation.

4. The crane according to claim 1,
wherein a time for increasing and decreasing the derricking angle for suppressing the swing is shorter than a swing period that is a time for the suspended load to perform a reciprocating swing.

5. The crane according to claim 1,
wherein an increase amount and a decrease amount of the derricking angle for suppressing the swing are equal to each other.

6. The crane according to claim 1,
wherein increasing and decreasing the derricking angle for suppressing the swing are performed during a decelerated turning of the rotating platform, after the rotating platform stops a turning, or both during the decelerated turning of the rotating platform and after the rotating platform stops the turning.

7. The crane according to claim 1,
wherein the crane has a normal mode in which swing suppression is not performed and a swing suppression mode in which the swing suppression is performed, and
the swing of the suspended load is suppressed by increasing and decreasing the derricking angle of the boom, in the swing suppression mode.

8. The crane according to claim 7, further comprising:
a detection device that detects the swing of the suspended load; and
a control unit that performs a transition to the swing suppression mode or that assists in the transition to the swing suppression mode, based on detection information of the detection device.

9. The crane according to claim 7, further comprising:
a control unit that performs a transition to the swing suppression mode or that assists in the transition to the swing suppression mode, based on a stop of a turning of the rotating platform or on deceleration of the turning.

10. The crane according to claim 9,
wherein the control unit includes
a mode switching control unit that performs switching control of an operation mode,
a manual operation control unit that performs operation control of the crane in a manual operation mode,
an automatic operation control unit that performs operation control of the crane in an automatic operation mode,
a swing suppression mode operation control unit that performs operation control of the crane in the swing suppression mode, and
an automatic operation setting processing unit that inputs setting information of an automatic operation via a manipulation panel.

11. The crane according to claim 10,
wherein the mode switching control unit, the manual operation control unit, the automatic operation control unit, the swing suppression mode operation control unit, and the automatic operation setting processing unit are software modules implemented by a CPU executing a control program.

12. The crane according to claim 11,
wherein the mode switching control unit determines whether or not there is a manipulation of the transition to the swing suppression mode, and switches, in a case where there is the manipulation of the transition to the swing suppression mode, the operation mode to the swing suppression mode.

13. The crane according to claim 12,
wherein the mode switching control unit determines whether or not the swing of the suspended load is equal to or greater than a predetermined threshold, and causes, in a case where the swing is equal to or greater than the predetermined threshold, the operation mode to transition to the swing suppression mode.

14. The crane according to claim 1, further comprising:
a lower structure disposed below the rotating platform,
wherein the rotating platform turns with respect to the lower structure,
the lower structure includes a movable traveling body,
the crane includes a wire rope hanging from the boom and suspending the suspended load, and
the rotating platform turns to turn the suspended load suspended by the wire rope.
